(19) United States
(12) Patent Application Publication
(10) Pub. No.: US 2022/0104994 A1
(43) Pub. Date: Apr. 7, 2022

(54) LipoRoller

(71) Applicants: Rocio Branz, Houston, TX (US); Steve Branz, Houston, TX (US)

(72) Inventors: Rocio Branz, Houston, TX (US); Steve Branz, Houston, TX (US)

(21) Appl. No.: 15/449,960

(22) Filed: Mar. 5, 2017

(51) Int. Cl. A61H 15/00

(52) U.S. Cl. CPC A61H 15/0092; A61H 2015/0014; A61H 2207/00

(57) ABSTRACT

For years, patients of liposuction have had to resort to ongoing, expensive post lipo massages with a masseuse specializing in lymphatic drainage as post liposuction treatment and care for smoothing, shaping and contouring their skin. In addition, some patients have had to resort to using unsanitary, wood baking rolling pins. Now with the LipoRoller, patients will have a safe, sanitary, effective tool to help shape, contour and smooth the skin following their procedures. Further, patients may administer this ‘self-massage’ to enhance their overall look and feel of their skin that will provide the best outcome of their procedure and obtain their desired result.

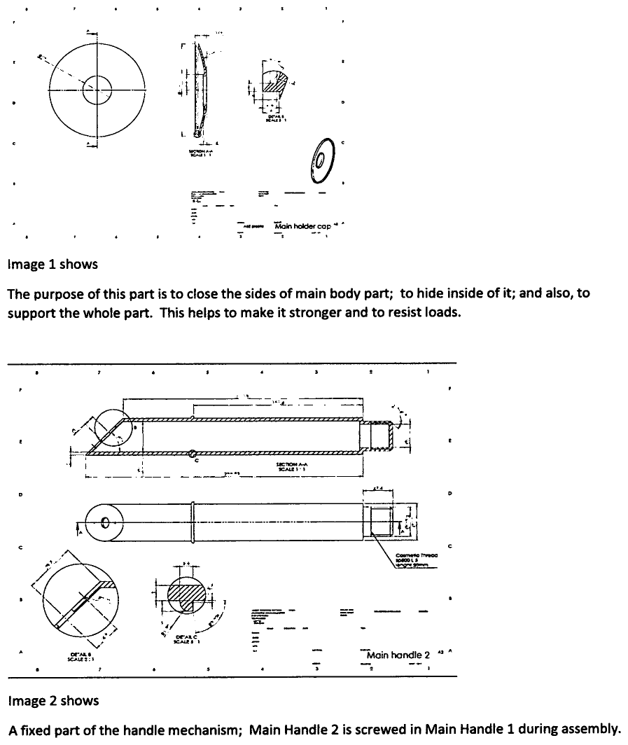

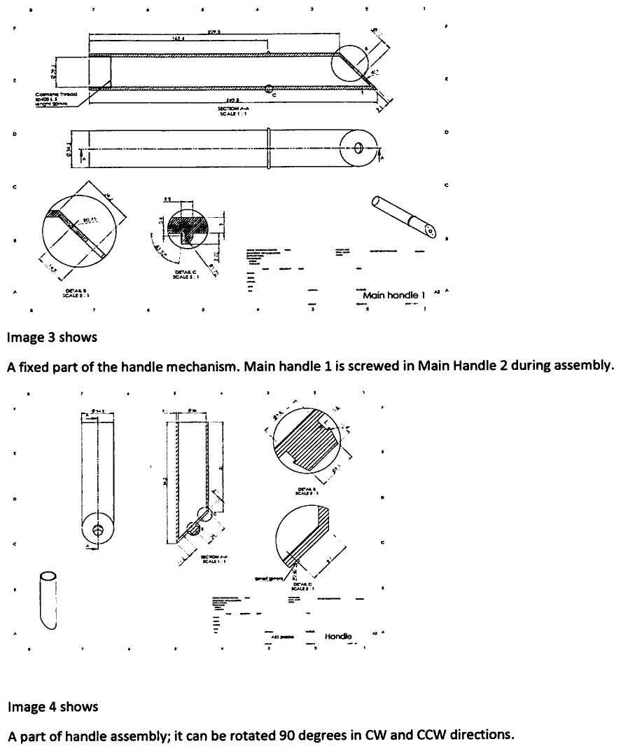

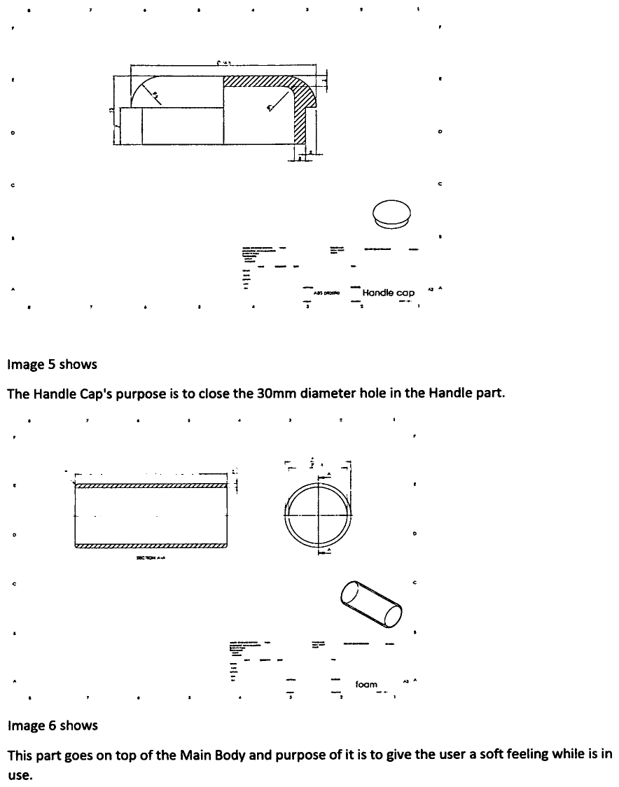

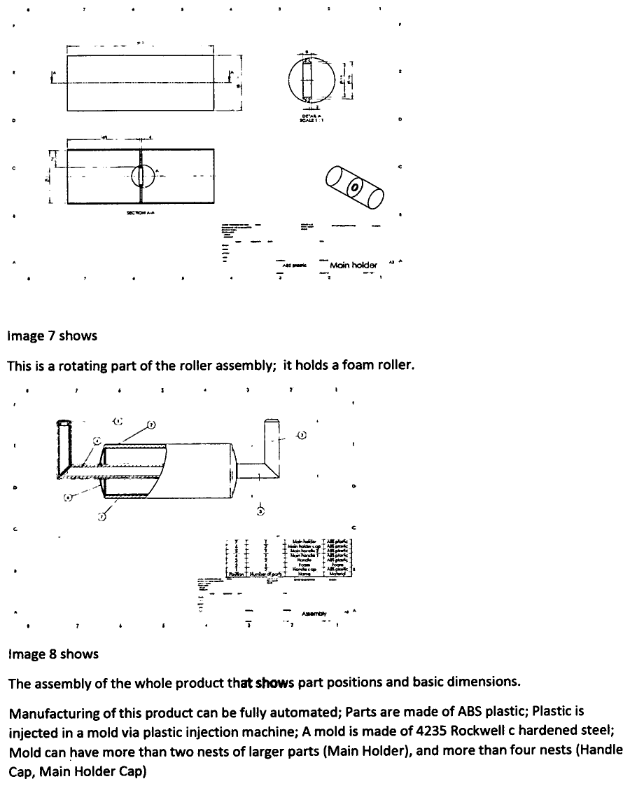

### BACKGROUND OF THE INVENTION

The LipoRoller is a safe and sanitary device that helps to smooth and contour the skin following a liposuction procedure. A doctor and/or the patient may utilize the device.

Polypropylene, ergonomically designed hand grips.

Length of device may be 16.5-18.25 inches in length.

Smooth EVA foam roller that is approximately 12 inches in length and is centred on the device; the EVA smooth foam centre will be approximately 2-3 inches in circumference and will rotate on a solid steel or hard plastic rod.

The EVA foam center will not contain any ridges, nodules, nobs, bumps or any type of raised, uneven surface.

The EVA smooth foam center will be one, continuous piece/roller; it will not have separate, multiple independent rollers.

The EVA smoother foam center will be of high-density EVA foam

Unlike massage roller sticks that are designed for muscle massage, the Liporoller is specifically designed for the patients of liposuction; any roller with ridges, nodules, nobs, bumps or any type of raised, uneven surface should not be used as it could leave marks on the skin and leave skin unsmooth.

Wood is unsafe for skin shaping and contouring as it may splinter further, it is unsanitary and may introduce bacteria into a healing area.

### DETAILED DESCRIPTION OF THE INVENTION

The LipoRoller helps a liposuction patient following surgery:

Helps to contour skin after procedure
Helps to break up scar tissue that creates lumpiness and unevenness
Reduces lymphatic congestion and swelling.
Promotes the flushing of toxins from the body.
Improves circulation of blood and lymphatic fluid.

Helps prevent fluid accumulation, which can cause a seroma.
May be used on the arms, stomach, back, and thighs.
It is not made from wood; wood is unsafe and unsanitary as it may splinter and introduce bacteria into a healing area of the procedure.
The handle can be manufactured in the straight position only.

The handle can be made in a 90° angle only.

1. The LipoRoller helps a liposuction patient following surgery.

2.-13. (canceled)
